(19) United States
(12) Patent Application Publication
(10) Pub. No.: US 2017/0171780 A1
(43) Pub. Date: Jun. 15, 2017

(54) TECHNIQUES FOR ADAPTING A RATE OF DATA TRANSMISSION

(71) Applicant: QUALCOMM Incorporated, San Diego, CA (US)

(72) Inventor: Kaushik BHATTACHARYA, Hyderabad (IN)

(21) Appl. No.: 14/968,213

(22) Filed: Dec. 14, 2015

(51) Int. Cl. H04W 28/22; H04L 12/825; H04L 29/08; H04W 76/02; H04L 12/26

(52) U.S. Cl. CPC H04W 28/22; H04W 76/023; H04L 43/0847; H04L 67/104; H04L 47/25

(57) ABSTRACT

Techniques for determining whether to adapt rates of data transmissions during point-to-point (P2P) communications are described. In an aspect, methods and apparatuses are described in which a transmitter device may identify a new rate of data transmission for a P2P connection with a receiver device, the new rate of data transmission being greater than a current rate of data transmission. Further, in an aspect, the transmitter device may determine a difference between a sensitivity of the receiver device associated with the current rate of data transmission and a sensitivity of the receiver device associated with the new rate of data transmission. Additionally, the transmitter device may compare the difference with one or more sensitivity thresholds. Finally, the transmitter device, based on the comparison, may determine whether to apply the new rate of data transmission to the P2P connection.

### BACKGROUND

Aspects of this disclosure relate generally to telecommunications, and more particularly to techniques for adapting a rate of data transmission.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

In some wireless communication networks, the data rate of a wireless station may be adapted using a rate adaptation (RA) algorithm in which the wireless station may attempt to ramp up the rate of data transmission when the current data rate is doing well. That is, the wireless station may attempt to transmit at a higher data rate to achieve higher throughput.

There may be scenarios in which transmitting at a higher data rate is not feasible or optimal, and the wireless station may not be aware of this until it tries to transmit at the higher rate. In such scenarios, accordingly, it may be desirable to accurately determine whether to adapt rates of data transmission during P2P communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a present method relates to determining whether to adapt rates of data transmission during point-to-point (P2P) communications. The described aspects include identifying, at a transmitter device, a new rate of data transmission for a P2P connection with a receiver device, the new rate of data transmission being greater than a current rate of data transmission. The described aspects further include determining a difference between a sensitivity of the receiver device associated with the current rate of data transmission and a sensitivity of the receiver device associated with the new rate of data transmission. The described aspects further include comparing the difference with one or more sensitivity thresholds. The described aspects further include determining, at the transmitter device and based on the comparison, whether to apply the new rate of data transmission to the P2P connection.

In another aspect, a present computer-readable medium (e.g., a non-transitory medium) storing computer executable code relates to determining whether to adapt rates of data transmission during P2P communications. The described aspects include code for identifying, at a transmitter device, a new rate of data transmission for a P2P connection with a receiver device, the new rate of data transmission being greater than a current rate of data transmission. The described aspects further include code for determining a difference between a sensitivity of the receiver device associated with the current rate of data transmission and a sensitivity of the receiver device associated with the new rate of data transmission. The described aspects further include code for comparing the difference with one or more sensitivity thresholds. The described aspects further include code for determining, at the transmitter device and based on the comparison, whether to apply the new rate of data transmission to the P2P connection.

In a further aspect, a present apparatus relates to determining whether to increase rates of data transmission during P2P communications. The described aspects include means for identifying, at a transmitter device, a new rate of data transmission for a P2P connection with a receiver device, the new rate of data transmission being greater than a current rate of data transmission. The described aspects further include means for determining a difference between a sensitivity of the receiver device associated with the current rate of data transmission and a sensitivity of the receiver device associated with the new rate of data transmission. The described aspects further include means for comparing the difference with one or more sensitivity thresholds. The described aspects further include means for determining, at the transmitter device and based on the comparison, whether to apply the new rate of data transmission to the P2P connection.

In another aspect, a present apparatus relates to determining whether to increase rates of data transmission during P2P communications. The described aspects include a transceiver, a memory configured to store data, and one or more processors communicatively coupled with the transceiver and the memory, wherein the one or more processors and the memory are configured to identify, at a transmitter device, a new rate of data transmission for a P2P connection with a receiver device, the new rate of data transmission being greater than a current rate of data transmission. The described aspects further determine a difference between a sensitivity of the receiver device associated with the current rate of data transmission and a sensitivity of the receiver device associated with the new rate of data transmission. The described aspects further compare the difference with one or more sensitivity thresholds. The described aspects further determine, at the transmitter device and based on the comparison, whether to apply the new rate of data transmission to the P2P connection.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a conceptual diagram illustrating an example of a wireless local area network (WLAN) deployment.

FIG. 2 is a schematic diagram of a communication network including aspects of a wireless device and a network entity, respectively, that may be configured for determining whether to adapt rates of data transmission during P2P communications in accordance with various aspects of the present disclosure.

FIGS. 3A-3D are diagrams illustrating adapting rates of data transmission during P2P communications in accordance with various aspects of the present disclosure.

FIG. 4 is a flow diagram illustrating an example method of adapting rates of data transmission during P2P communications in accordance with various aspects of the present disclosure.

FIG. 5 is a flow diagram illustrating an example method of adapting rates of data transmission during P2P communications in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to determining whether to adapt rates of data transmission during point-to-point (P2P) communications. In an aspect, for example, in some wireless communication networks, wireless stations may communicate with one another directly. This type of communication is often referred to as P2P communication and may occur using Wi-Fi techniques (e.g., Wi-Fi Direct or Wi-Fi P2P). The data rate of a wireless station in a P2P scenario may be adapted using a rate adaptation (RA) procedure in which the wireless station may attempt to ramp up the rate of data transmission when the current data rate is doing well. That is, the wireless station may attempt to transmit at a higher data rate to achieve higher throughput.

One issue that may arise is that the sensitivity of a receiver device (e.g., a receiving wireless station) may be different for different data rates. That is, hardware in the receiver device may have different sensitivities for the higher data rate that the RA procedure is trying to achieve and the current data rate that is being used. For example, when a data packet is transmitted at a data rate for which a link budget is not sufficient (e.g., the signal-to-noise (SNR) at the receiver device is not sufficient to properly handle the coding and modulation of that data rate); the data packet will likely need to be retransmitted. As a result, the throughput for that P2P connection will drop and so will the throughput of the overall network as a result of air bandwidth being misused (e.g., wasted). There are no mechanisms in place to know before actually transmitting at the higher data rate if such a data rate will be effective or not. Additionally, in user datagram protocol (UDP) and transmission control protocol (TCP) cases the packet length is (in general for peak throughput cases but not limited to) 1550 bytes. Therefore, such a long packet has to be retransmitted again, which results in delays and lower throughputs. Moreover, because an unsuccessful transmission could result from something other than receiver sensitivity (e.g., collision), most RA procedures may try to use the higher rate for a certain amount of time before deciding to reduce the data rate to a lower, more robust data rate. This in turn causes the throughput to be affected for some time before the transmitter device (e.g., the wireless station under test) realizes that the higher data rate it wants to achieve is not usable and falls back to the older data rate or to an even lower data rate depending on implementation. This situation tends to produce rate toggling during operations.

Accordingly, in some aspects, the present methods and apparatuses may provide an efficient solution, as compared to current solutions, by determining whether to adapt rates of data transmission during P2P communications. In other words, in the present aspects, a device may be capable of adapting a rate of data transmission. As such, the present aspects provide one or more mechanisms for identifying, at a transmitter device, a new rate of data transmission for a P2P connection with a receiver device, the new rate of data transmission being greater than a current rate of data transmission. The present aspects further provide for determining a difference between a sensitivity of the receiver device associated with the current rate of data transmission and a sensitivity of the receiver device associated with the new rate of data transmission. The present aspects further provide for comparing the difference with one or more sensitivity thresholds. The present aspects further provide for determining, at the transmitter device and based on the comparison, whether to apply the new rate of data transmission to the P2P connection.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

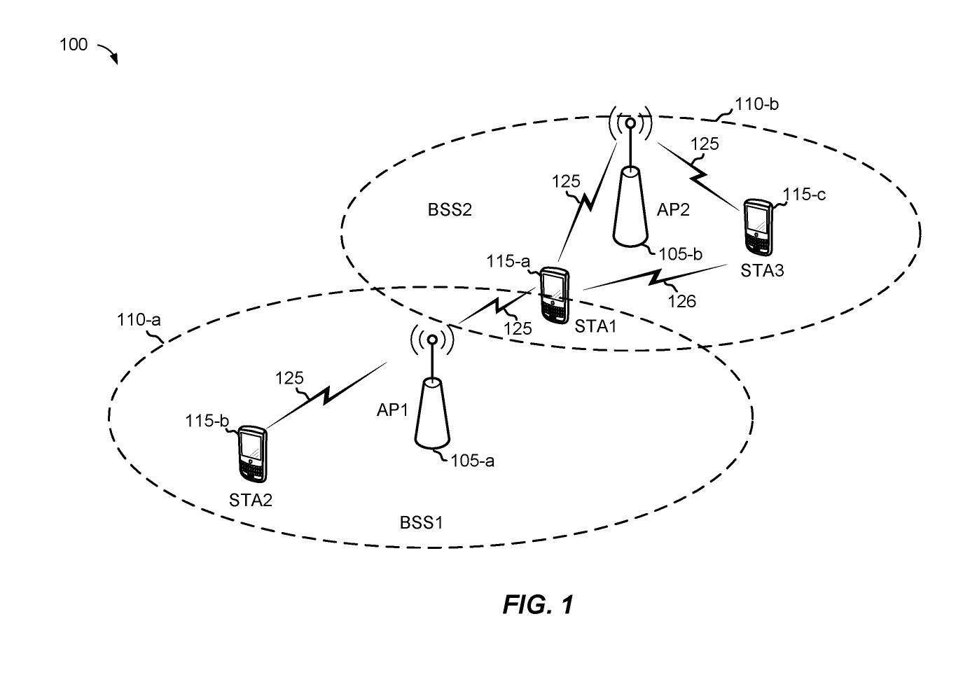

FIG. 1 is a wireless communication system 100 illustrating an example of a wireless local area network (WLAN) deployment in connection with various techniques described herein. The WLAN deployment may include one or more access points (APs) and one or more mobile stations (STAs) associated with a respective AP. In this example, there are only two APs deployed for illustrative purposes: AP1 105-a in basic service set 1 (BSS1) and AP2 105-b in BSS2. AP1 105-a is shown having at least two associated STAs (STA1 115-a and STA2 115-b) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for determining a device location may be applicable to any suitable wireless network regardless of the coverage range and the wireless access protocols utilized.

In one aspect, an STA or an AP as shown in FIG. 1 may be capable of determining whether to adapt rates of data transmission during point-to-point (P2P) communications. As such, the present aspects provide one or more mechanisms for identifying, at a transmitter device, a new rate of data transmission for a P2P connection with a receiver device, the new rate of data transmission being greater than a current rate of data transmission. For example, an STA, such as STA1 115-a (e.g., transmitter device) may communicate directly (e.g., a P2P connection) via communications link 126 with another STA, such as STA3 115-c (e.g., receiver device). STA1 115-a may identify a new rate of data transmission for the P2P connection with STA3 115-c. Moreover, the transmitter device, may determine a difference between a sensitivity of the receiver device associated with the current rate of data transmission and a sensitivity of the receiver device associated with the new rate of data transmission. For example, the hardware (e.g., radio frequency (RF) front end components) of STA3 115-c may be configured with specific sensitivities at certain rates of data transmission. As such, STA1 115-a may determine a difference between a sensitivity of STA3 115-c associated with the current rate of data transmission and a sensitivity of STA3 115-c associated with the new rate of data transmission. Further, the transmitter device may compare the difference with one or more sensitivity thresholds. For example, STA1 115-a may compare the difference with one or more sensitivity thresholds. Finally, the transmitter device may determine based on the comparison, whether to apply the new rate of data transmission to the P2P connection. For example, if STA1 115-a determines based on the comparison that STA3 115-c may be able to handle the higher rate of data transmission, then STA1 115-a may apply the higher rate of data transmission for the P2P connection. By making this determination prior to the application of the higher rate of data transmission, it is possible to avoid a drop in throughput and/or a rate toggling conditions. While this example has been presented with respect to two STAs in the WLAN deployment in FIG. 1, a similar approach may be followed between an AP and an STA, or between an STA and an AP.

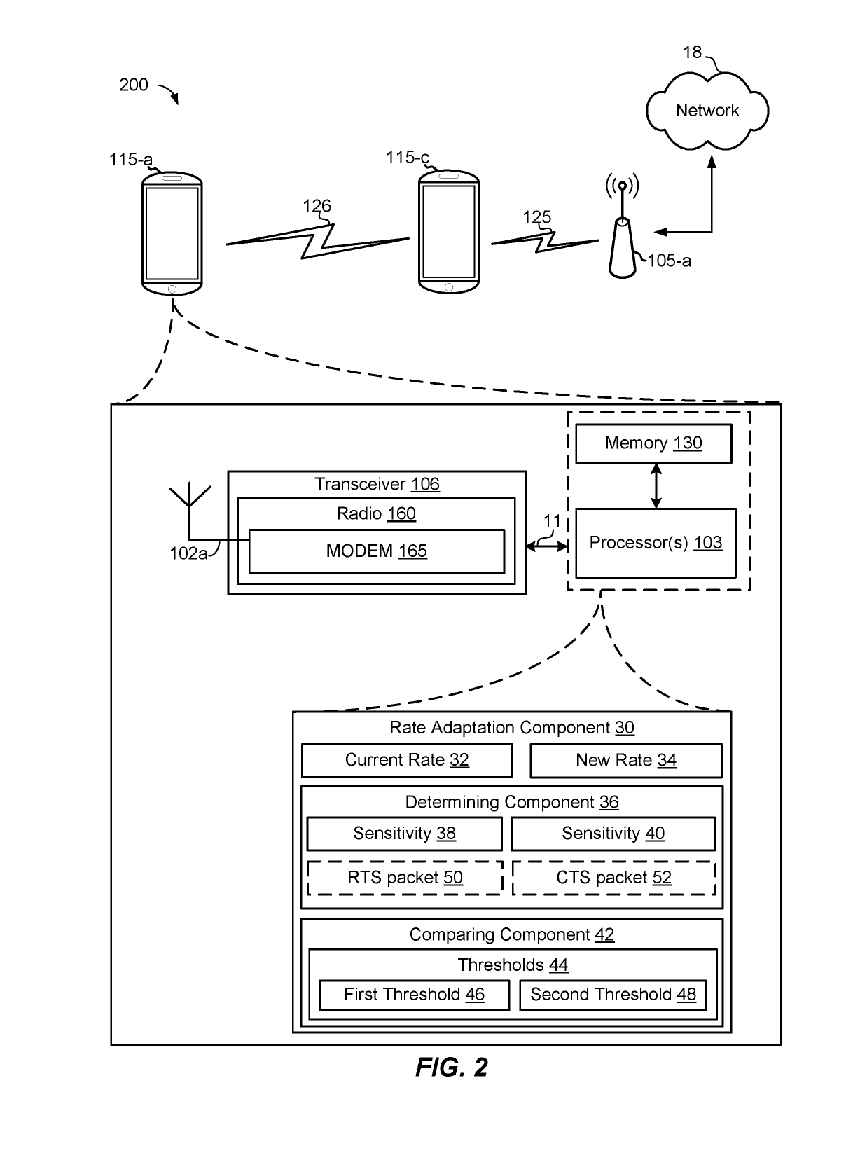

Referring to FIG. 2, in an aspect, a wireless communication system 200 includes STAs 115-a and 115-c in direct communication with one another (e.g., P2P communication) and in communication coverage of at least one AP2 105-b connected to network 18, similar to STAs 115-a and 115-c, and AP2 105-b of FIG. 1. The STAs 115-a and 115-c may communicate with network 18 via AP2 105-b. In an example, STAs 115-a and 115-c may transmit and/or receive wireless communication to and/or from AP2 105-b via one or more communication link 125, which may include an uplink communication channel (or simply uplink channel) and a downlink communication channel (or simply downlink channel), such as but not limited to an uplink data channel and/or downlink data channel. Such wireless communications may include, but are not limited to, data, audio and/or video information. In an aspect, STA1 115-a and/or 115-c may be configured to determine whether to adapt rates of data transmission during P2P communications. For example, STA1 115-a may be transmitting data at a current rate 32 with a receiving device, such as STA3 115-c.

In accordance with the present disclosure, STA1 115-a may include a memory 130, one or more processors 103 and a transceiver 106. The memory, one or more processors 103 and the transceiver 106 may communicate internally via a bus 11. In some examples, the memory 130 and the one or more processors 103 may be part of the same hardware component (e.g., may be part of a same board, module, or integrated circuit). Alternatively, the memory 130 and the one or more processors 103 may be separate components that may act in conjunction with one another. In some aspects, the bus 11 may be a communication system that transfers data between multiple components and subcomponents of the STA1 115-a. In some examples, the one or more processors 103 may include any one or combination of modem processor, baseband processor, digital signal processor, and/or transmit processor. Additionally or alternatively, the one or more processors 103 may include a rate adaptation component 30 for carrying out one or more methods or procedures described herein. The rate adaptation component 30 may comprise hardware, firmware, and/or software and may be configured to execute code or perform instructions stored in a memory (e.g., a computer-readable storage medium).

In some examples, the STA1 115-a may include the memory 130, such as for storing data used herein and/or local versions of applications or rate adaptation component 30 and/or one or more of its subcomponents being executed by the one or more processors 103. Memory 130 can include any type of computer-readable medium usable by a computer or processor 103, such as random access memory (RAM), read only memory (ROM), tapes, magnetic discs, optical discs, volatile memory, non-volatile memory, and any combination thereof. In an aspect, for example, memory 130 may be a computer-readable storage medium (e.g., a non-transitory medium) that stores computer-executable code. The computer-executable code may define one or more operations or functions of rate adaptation component 30 and/or one or more of its subcomponents, and/or data associated therewith. The computer-executable code may define these one or more operations or functions when STA1 115-a is operating processor 103 to execute rate adaptation component 30 and/or one or more of its subcomponents. In some examples, the STA1 115-a may further include a transceiver 106 for transmitting and/or receiving one or more data and control signals to/from the network 18 via AP2 105-b or STA3 115-c. The transceiver 106 may comprise hardware, firmware, and/or software and may be configured to execute code or perform instructions stored in a memory (e.g., a computer-readable storage medium). The transceiver 106 may include a radio 160 comprising a modem 165. In an aspect, the radio 160 supports a radio access technology that enables P2P connections such as a wireless local area network (WLAN) or a short distance communication protocol (e.g., Bluetooth radio). The radio 160 may utilize one or more antennas 102a for transmitting signals to and receiving signals from the STA3 115-c and/or AP2 105-b.

In an aspect, system 200 may include STA1 115-a, and which STA1 115-a may include a rate adaptation component 30 having a determining component 36 and a comparing component 42. For example, STA1 115-a may be configured for or may identify a new rate of data transmission (e.g., new rate 34) for a P2P connection (e.g., communication link 126) with a receiver device (e.g., STA3 115-c), the new rate 34 of data transmission being greater than a current rate 32 of data transmission. In an aspect, current rate 32 and new rate 34 may be provided in a list and/or table stored in memory 130 and/or provided via network 18. The current rate 32 and new rate 34 of data transmissions may be measured in megabits per second (Mbps). For example, STA1 115-a may configure current rate 32 of data transmission at 6 Mbps. Further, STA1 115-a may identify the new rate 34 of data transmission at either 9, 12, 24, or 36 Mbps. These possible new rates of data transmission may be identified from a list and/or table in which the new rates of data transmissions are associated with corresponding receiver sensitivities (e.g., sensitivity 38 and/or 40). Similarly, sensitivity 38 and sensitivity 40 may be provided in a list and/or table stored in memory 130 and/or provided via network 18. In an aspect, sensitivity 38 and sensitivity 40 may correspond to the minimum signal energy required to sustain a minimum quality at the output of a digital signal processor (DSP) block (e.g., 10% bit error rate). Further, sensitivity 38 and sensitivity 40 may be measured in decibel-milliwatts (dBm). In another aspect, current rate 32 and new rate 34 may be computed. In these aspects, rate adaptation component 30 may be configured to identify the proper rate (e.g., current rate 32 and new rate 34) and sensitivity (e.g., sensitivity 38 and sensitivity 40) based on the list and/or table. For example, rate adaptation component 30 may determine the current rate 32 and based on the list and/or table match a new rate 34 with the current rate 32. Similarly, rate adaptation component 30 may determine the sensitivity 38 and sensitivity 40 based on the list and/or table by comparing the sensitivities matched with the current rate 32 and the new rate 34, respectively.

In an aspect, STA1 115-a and/or rate adaptation component 30 may execute determining component 36 to determine a difference between a sensitivity 38 of the receiver device (e.g., STA3 115-c) associated with the current rate 32 of data transmission and a sensitivity 40 of the receiver device associated with the new rate 34 of data transmission. In this aspect, for example, sensitivity 38 may have a value of X dBm while sensitivity 40 may have a value of Y dBm, where X and Y are values greater than 1. In an aspect, the difference between sensitivity 38 of the receiver device (e.g., STA3 115-c) associated with the current rate 32 of data transmission and sensitivity 40 of the receiver device associated with the new rate 34 of data transmission may be measured in dB. For example, determining component 36 may determine whether application of the new rate 34 of data transmission results in an increase in throughput for the P2P connection between STA1 115-a and STA3 115-c. Rate adaptation component 30 may apply the new rate 34 of data transmission to the P2P connection in response to the determining component 36 determining that application of the new rate 34 of data transmission will result in an increase in throughput for the P2P connection. In a further aspect, determining component 36 may determine to apply the new rate 34 of data transmission based in part on the comparison of the difference between the sensitivity 38 of the receiver device (e.g., STA3 115-c) associated with the current rate 32 of data transmission and a sensitivity 40 of the receiver device associated with the new rate 34 of data transmission with one or more sensitivity thresholds 44.

In an aspect, STA1 115-a and/or rate adaptation component 30 may execute comparing component 42 to compare the difference between the sensitivity 38 of the receiver device (e.g., STA3 115-c) associated with the current rate 32 of data transmission and a sensitivity 40 of the receiver device associated with the new rate 34 of data transmission with one or more sensitivity thresholds 44. For example, the one or more sensitivity thresholds 44 may include a first threshold 46 and a second threshold 48. Both first threshold 46 and second threshold 48 may correspond to thresholds for sensitivity of the hardware of a receiving device. For example, first threshold 46 may have a value of THRES1 dBm, and second threshold 48 may have a value of THRES2 dBm, where THRES1 and THRES2 are values greater than 1. In an example, comparing component 42 may compare the difference with the one or more sensitivity thresholds 44 comprises determining that the difference is less than a first sensitivity threshold 46. For example, the current rate 32 of data transmissions is 6 Mbps, and sensitivity 38 is identified as X dBm, rate adaptation component 30 may determine whether to adjust the rate of data transmissions to new rate 34 of data transmissions (e.g., 9 Mbps) with a sensitivity 40 (e.g., Y dBm). Comparing component 42 may compare the difference between sensitivity 38 and sensitivity 40 (e.g., the difference=X−Y) and determine that the difference is less than THRES1. The determining component 36 may then determine whether a packet error rate (PER) of the current rate 32 of data transmission is less than a PER threshold. In an instance, the PER is the total number of data packets successfully transmitted for which an acknowledgement (ACK) signal was received divided by the total number of transmitted data packets. A data packet is declared as an error if the data packet is transmitted but an ACK signal is never received in response. In some instances, the PER threshold may be preconfigured or may be adjustable based on the current rate 32 of data transmission or a sensitivity 38 of the receiver device associate with the current rate 32 of data transmission. Rate adaptation component 30 may apply the new rate 34 of data transmission to the P2P connection in response to a determination, by determining component 36, that the difference is less than a first threshold 46.

In another aspect, comparing component 42 may be configured to determine that the difference between the sensitivity 38 of the receiver device (e.g., STA3 115-c) associated with the current rate 32 of data transmission and a sensitivity 40 of the receiver device associated with the new rate 34 of data transmission is greater than a first threshold 46 and less than a second threshold 48. For example, the current rate 32 of data transmissions is 6 Mbps, and sensitivity 38 is identified as X dBm, rate adaptation component 30 may determine whether to adjust the rate of data transmissions to new rate 34 of data transmissions (e.g., 18 Mbps) with a sensitivity 40 (e.g., Y dBm). Comparing component 42 may compare the difference between sensitivity 38 and sensitivity 40 (e.g., the difference=X−Y) and determine that the difference is greater than THRES1 but less than THRES2. As such, determining component 36 may be configured to determine whether to apply the new rate 34 of data transmission to the P2P connection by applying the new rate 34 of data transmission to Request-to-Send/Clear-to-Send (RTS-CTS) packet communications with the receiver device in response to a determination that the difference is greater than the first threshold 46 and less than the second threshold 48. In an instance, RTS-CTS packet communications is a mechanism used by wireless networking protocols to reduce frame collisions introduced by the hidden node problem. In an example, a first STA (e.g., STA1 115-a) initiates the process by sending a RTS packet 50. The second STA (e.g., STA3 115-c) receives the RTS packet 50 and responds with a CTS packet 52. The first STA must receive a CTS packet 52 before sending a data transmission. The CTS packet 52 also includes a time value that alerts other STAs and/or access points to hold off from accessing the communication medium while the first STA initiating the RTS packet 50 transmits its data. As stated, in this example, STA1 115-a and/or rate adaptation component 30 may be configured to transmit to the receiver device (e.g., STA3 115-c) an RTS packet 50 indicating a transmit power of the transmitter device (e.g., STA1 115-a). STA1 115-a and/or rate adaptation component 30 may be configured to receive from the receiver device a CTS packet 52 indicating a correct transmit power of the transmitter device of the transmitter for the new rate 34 of data transmission.

In certain instances, STA1 115-a and/or rate adaptation component 30 may need to retransmit the RTS packet 50 to the receiver device (e.g., STA3 115-c). For example, STA1 115-a and/or rate adaptation component 30 may not retransmit the RTS packet 50 if a CTS packet 52 has not been received within a certain period of time. In these instances, determining component 36 may be configured to determine whether a number of RTS packet retransmissions exceeds a retransmission threshold. Rate adaptation component 30 may then apply the current rate 32 of data transmission to the P2P connection in response to the determining component 36 determining that the number of RTS packet retransmissions exceeds the retransmission threshold. For example, the determining component 36 may configure the retransmission threshold at 50 percent (%). In other words, determining component 36 determines whether 50% of RTS packets are successfully transmitted. If determining component 36 determines that 50% of the RTS packets are not successfully transmitted then rate adaptation component 30 may proceed with adapting to the new rate 34 of data transmissions. However, if determining component 36 determines that 50% of the RTS packets are not successfully transmitted then rate adaptation component 30 may maintain the current rate 32 of data transmissions. Similarly, determining component 36 may determine whether the transmission of one or more RTS packets 50 are successfully transmitted to the receiver device. Rate adaptation component 30 may apply the new rate 34 of data transmission to the P2P connection in response to the determination that the one or more RTS packet 50 transmissions are successfully transmitted to the receiver device. Otherwise, rate adaptation component 30 may configure determining component 36 to continue monitoring whether one or more RTS packet 50 transmissions are successfully transmitted to the receiver device if one or more RTS packet 50 transmissions have yet to be successfully transmitted. Once rate adaptation component 30 has applied the current rate 32 or the new rate 34 of data transmission, rate adaptation component 30 may configure STA1 115-a to cease RTS-CTS packet communications with the receiver device.

In a further aspect, comparing component 42 may be configured to determine that the difference between the sensitivity 38 of the receiver device (e.g., STA3 115-c) associated with the current rate 32 of data transmission and a sensitivity 40 of the receiver device associated with the new rate 34 of data transmission is greater than a first threshold 46 and a second threshold 48. For example, the current rate 32 of data transmissions is 6 Mbps, and sensitivity 38 is identified as X dBm, rate adaptation component 30 may determine whether to adjust the rate of data transmissions to new rate 34 of data transmissions (e.g., 24 Mbps) with a sensitivity 40 (e.g., Y dBm). Comparing component 42 may compare the difference between sensitivity 38 and sensitivity 40 (e.g., the difference=X−Y) and determine that the difference is greater than THRES2. As such, rate adaptation component 30 may apply the current rate 32 of data transmission to RTS-CTS packet communications with the receiver device in response to a determination that the difference is greater than the first threshold 46 and the second threshold 48. In another aspect, rate adaptation component 30 may apply a rate of data transmission corresponding to a previously successful rate of data transmission to RTS-CTS packet communications with the receiver device in response to a determination that the difference is greater than the first threshold 46 and the second threshold 48. In this aspect, the previously successful rate of data transmission may correspond to the current rate 32 of data transmission or may correspond to a higher or lower rate of data transmission than the current rate 32 of data transmission (e.g., the new rate 34 of data transmission). In this aspect, STA1 115-a and/or rate adaptation component 30 may receive an indication from a CTS packet 52 for a highest possible rate of data transmission and one or more reserve bits in a service field of the CTS packet 52 for a transmit power.

In another aspect, determining component 36 may determine whether to apply the new rate 34 of data transmission to the P2P connection by determining whether to use one or both of short data packets or null data packets for communication. For example, determining component 36 may indicate to STA1 115-a and/or rate adaptation component 30 to communicate, with the receiver device (e.g., STA3 115-c), one or both of short data packets or null data packets at the current rate 32 of data transmission or the new rate 34 of data transmission based on the comparison of the difference between the sensitivity 38 of the receiver device (e.g., STA3 115-c) associated with the current rate 32 of data transmission and a sensitivity 40 of the receiver device associated with the new rate 34 of data transmission with one or more sensitivity thresholds 44.

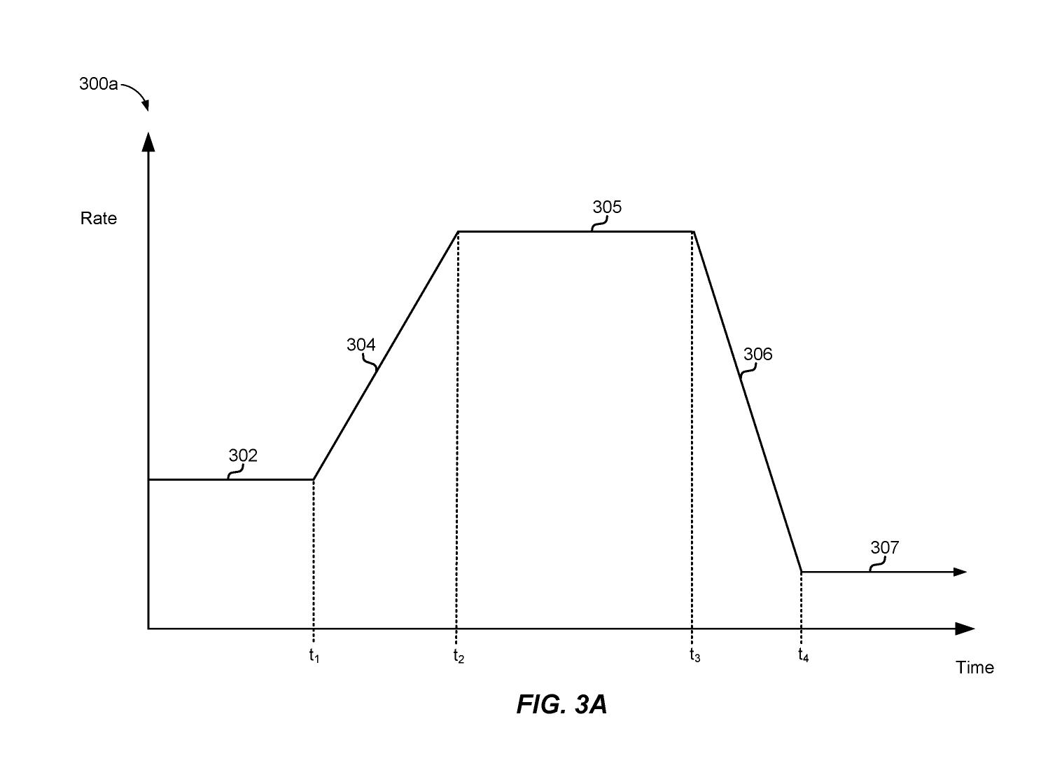

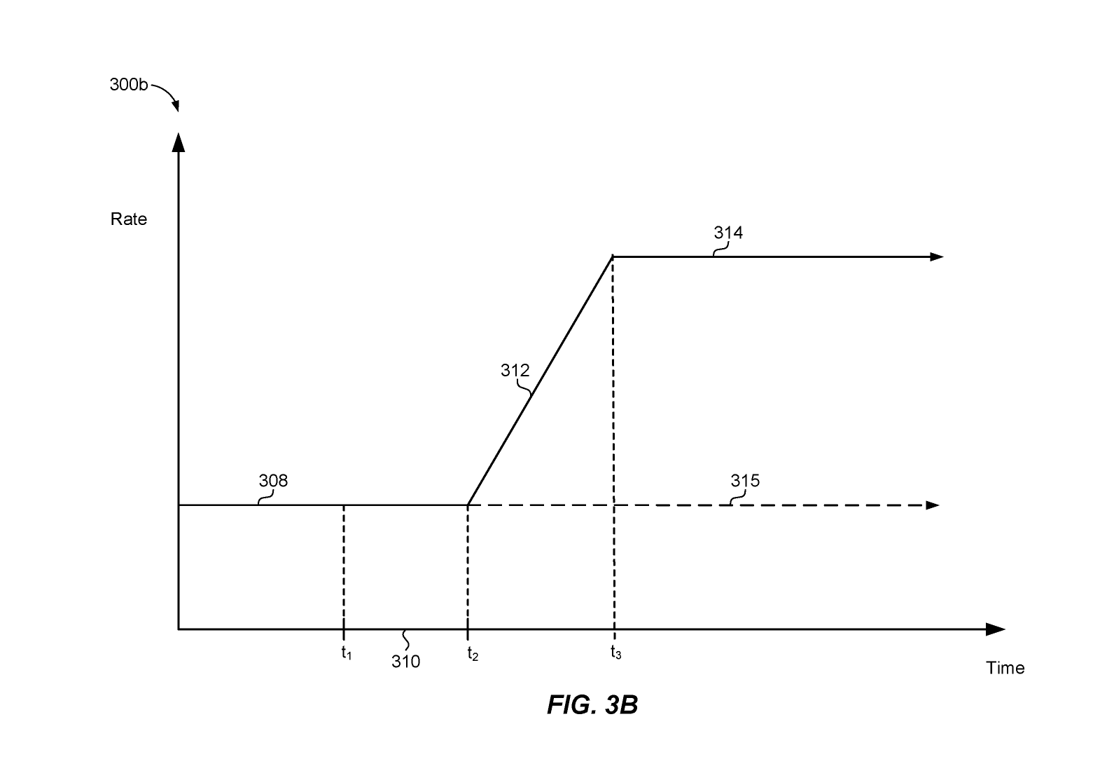

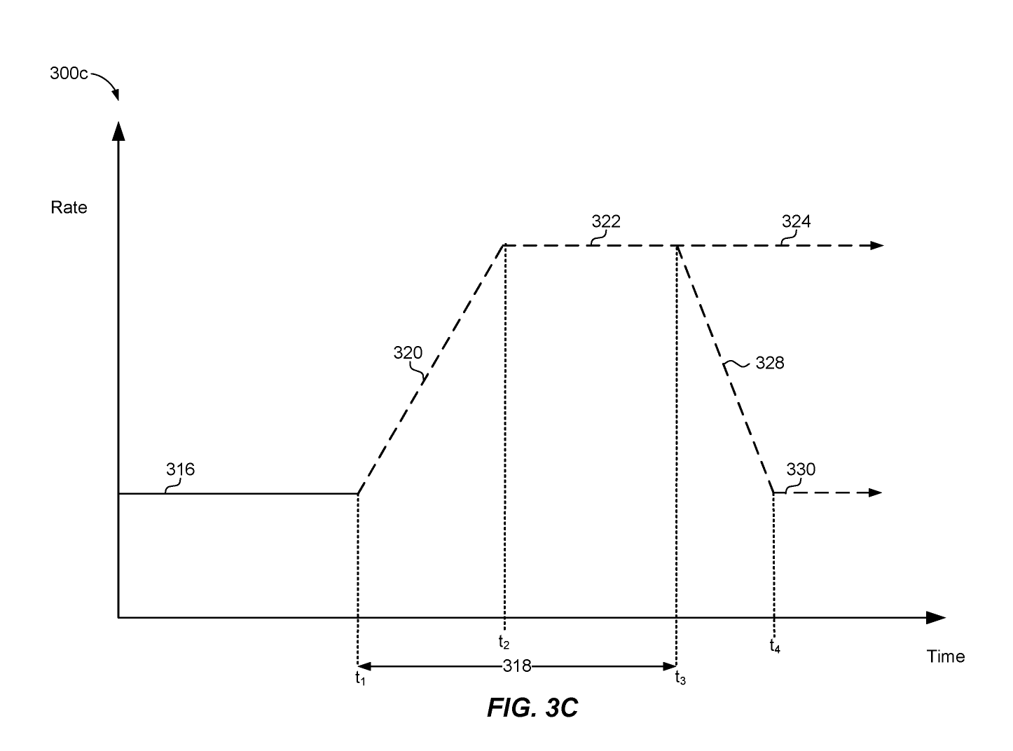

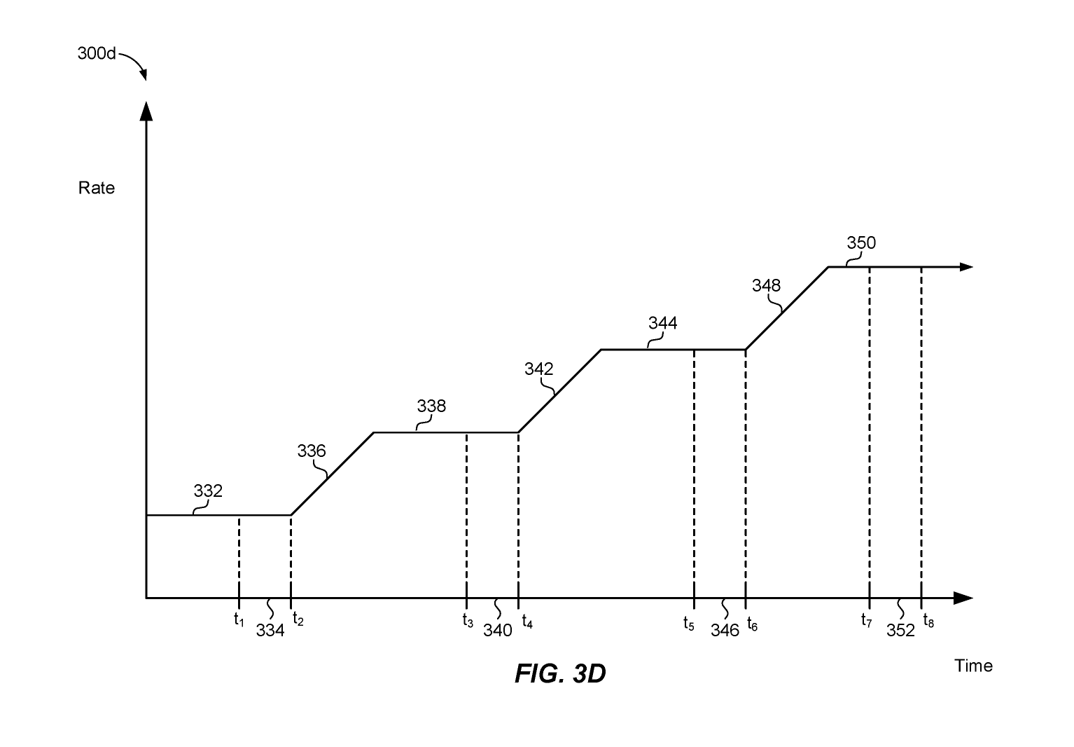

FIGS. 3A-3D illustrate diagrams corresponding to rate adaptation of the rate of data transmission between a transmitter device in a P2P connection with a receiver device. For example, in an aspect, FIGS. 3A-3D may depict a comparison of the rate of data transmission over time for a wireless device, such as wireless device 115-a of FIG. 2, in a P2P connection with another wireless device, such as STA3 115-c of FIG. 2. In particular, each of FIGS. 3A-3D illustrate different examples of rate adaptation procedures corresponding to rate adaptations performed by rate adaptation component 30 of STA1 115-a (FIG. 2).

In an aspect, FIG. 3A illustrates an example diagram 300a for adapting a rate over time during a P2P connection. In this example, a first STA may be transmitting data at a current rate 302 to a second STA. As depicted, the first STA may not properly implement a rate adaptation procedure to determine whether to adapt rates of data transmission during P2P communications so as to ensure that rate toggling and ramp downs do not occur. Without performing the rate adaptation procedure (as described with respect to rate adaptation component 30 of FIG. 2), the first STA may ramp up 304, at time t₁, the current rate 302 to a new rate 305 of data transmissions, at time t₂. The new rate 305 may be higher than the current rate 302. However, due to receiver sensitivity at the second STA, the higher rate 305 may cause the throughput to be negatively affected due to unsuccessful data transmissions. As such, at time t₃, the first STA may realize that the higher rate 305 is unusable, and so, the first STA begins to ramp down 306 to a lower rate 307, at time t₄. In this instance, the lower rate 307 may lower than the previous current rate 302. In these instances, depending on the implementation of the first STA and/or the second STA, the rate of data transmissions me be forced to ramp down to lower rates of data transmission than the rate of data transmission before the ramp up occurred.

In another aspect, FIG. 3B illustrates an example diagram 300b for adapting a rate over time during a P2P connection. In this example, a first STA may be transmitting data at a current rate 308 to a second STA. As depicted, the first STA may be configured to perform a rate adaptation procedure to determine whether to adapt rates of data transmission during P2P communications so as to ensure that rate toggling and ramp downs do not occur. As such, for a period of time 310 starting at time t₁, the first STA may be configured to determine based on a comparison of a difference between a sensitivity of the second STA associate with the current rate 308 and a sensitivity of the second STA associated with the new rate 314 of data transmission, whether to apply the new rate 314 of data transmission to the P2P connection. If the first STA determines to apply the new rate 314 of data transmission, then, at time t₂, the first STA may ramp up 312 from the current rate 308 to the new rate 314, at time t₃. However, if, at time t₂, the first STA determines not to apply the new rate 314, then the first STA may continue to use the current rate 315. As a result, forced ramp downs and issues with throughput are prevented by performing the rate adaptation procedures.

In another aspect, FIG. 3C illustrates an example diagram 300c for adapting a rate over time during a P2P connection. In this example, a first STA may be transmitting data at a current rate 316 with a second STA. As depicted, the first STA may be configured to perform a rate adaptation procedure, beginning at time t₁, to determine whether to adapt rates of data transmission during P2P communications so as to ensure that rate toggling and ramp downs do not occur. As such, for a period of time 318, the first STA may be configured to determine based on a comparison of a difference between a sensitivity of the second STA associate with the current rate 316 and a sensitivity of the second STA associated with the new rate 324 of data transmission, whether to apply the new rate 324 of data transmission to the P2P connection. Furthermore, during the period of time 318, the first STA may determine whether to apply the new rate 324 by applying the new rate 324 to RTS-CTS packet communications with the second STA. In this example, the first STA may ramp up 320, at time t₂, the transmissions to transmit RTS packets at higher rate 322 to the second STA. Second STA may transmit CTS packets at the higher rate 322 to first STA. If the first STA determines, at time t₃, that one or more RTS packet transmissions are successfully received at the second STA then first STA may apply the new rate 324 to all data transmissions and cease RTS-CTS communications. However, if the first STA determines, at time t₃, that the number of RTS packet retransmissions exceeds a retransmission threshold, then the first STA may ramp down 328 the rate of transmission and continue transmitting, at time t₄, data at a lower rate 330 of data transmission (which may be configured to be equal to the previous current rate 316 of data transmission).

Additionally, FIG. 3D illustrates an example diagram 300d for adapting a rate over time during a P2P connection. In this example, a first STA may be transmitting data at a current rate 332 with a second STA. As depicted, the first STA may be configured to perform, at time t₁, a rate adaptation procedure to determine whether to adapt rates of data transmission during P2P communications so as to ensure that rate toggling and ramp downs do not occur. As such, for a period of time 334, the first STA may be configured to determine based on a comparison of a difference between a sensitivity of the second STA associate with the current rate 332 and a sensitivity of the second STA associated with the new rate 338 of data transmission, whether to apply the new rate 338 of data transmission to the P2P connection. If the first STA determines, at time t₂, to apply the new rate 338 of data transmission, then the first STA may ramp up 336 from the current rate 332 to the new rate 338. This rate adaptation procedure may be repeated until the first STA determines not to apply a new higher rate of data transmission. For example, the first STA may determine to apply a new rate 344 during a period of time 340, from time t₃ to t₄, after ramping up 336 to new rate 338. As such, the first STA may ramp up 342 from new rate 338 to new rate 344. Similarly, after ramping up to new rate 344, the first STA may again determine, during a period of time 346, from time t₅ to t₆, to ramp up 348 to new rate 350. After ramping up to new rate 350, the first STA may determine whether to apply a new higher rate of data transmission to the P2P connection. However, during a period of time 352, from time t₇ to t₈, the first STA may determine not to apply a new higher rate of data transmission. As such, the first STA may maintain the new rate 350 of data transmission. This new rate 350 may indicate the highest possible rate of data transmission capable based on the sensitivity of second STA.

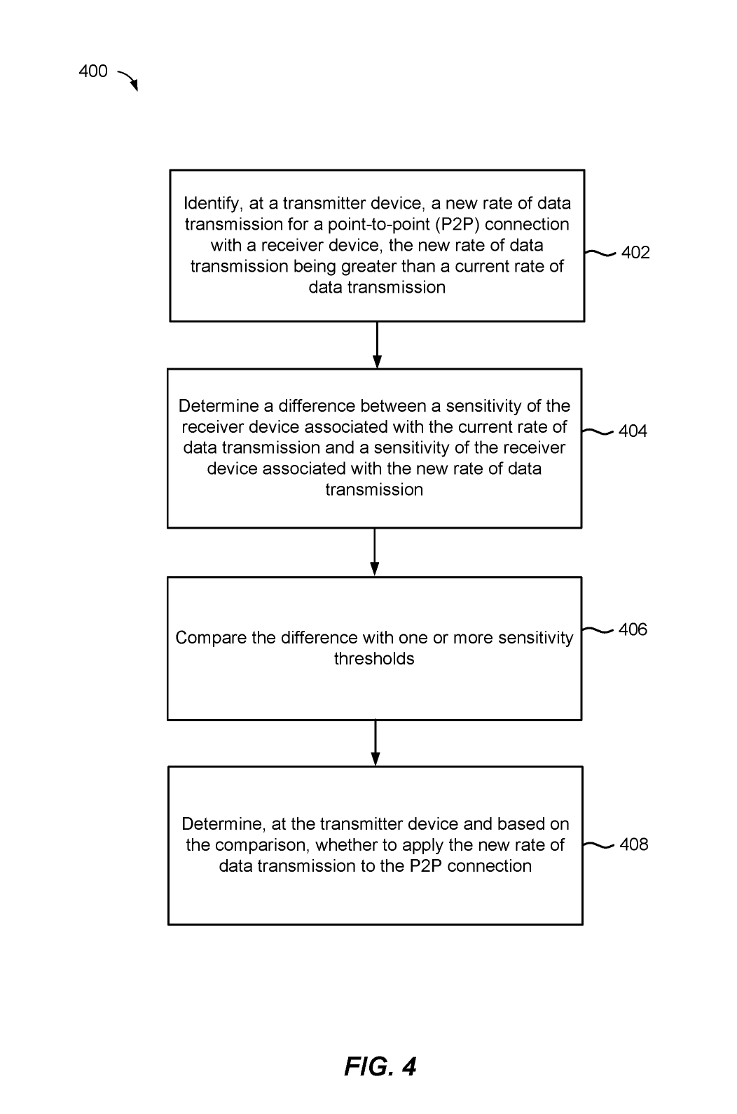

Referring to FIG. 4, an example of one or more operations of an aspect of rate adaptation component 30 (FIG. 2) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the rate adaptation component 30 is illustrated as having a number of subcomponents, it should be understood that one or more of the illustrated subcomponent may be separate from, but in communication with, the rate adaptation component 30 and/or each other. Moreover, it should be understood that the following actions or components described with respect to the rate adaptation component 30 and/or its subcomponents may be performed by a specially-programmed processor, a processor executing specially-programmed software or computer-readable media, or by any other combination of a hardware component and/or a software component specially configured for performing the described actions or components.

In an aspect, at block 402, method 400 includes identifying, at a transmitter device, a new rate of data transmission for a point-to-point (P2P) connection with a receiver device, the new rate of data transmission being greater than a current rate of data transmission. In an aspect, for example, STA1 115-a may execute rate adaptation component 30 to identify a new rate 34 of data transmission for a P2P connection with a receiver device (e.g., STA3 115-c), the new rate 34 of data transmission being greater than a current rate 32 of data transmission. In another aspect, block 402 may provide a means for identifying, at a transmitter device, a new rate of data transmission for a P2P connection with a receiver device, the new rate of data transmission being greater than a current rate of data transmission. For example, the means for identifying may correspond to one or more of a STA1 115-a, processor 103, or rate adaptation component 30.

In an aspect, at block 404, method 400 includes determining a difference between a sensitivity of the receiver device associated with the current rate of data transmission and a sensitivity of the receiver device associated with the new rate of data transmission. In an aspect, for example, STA1 115-a may execute rate adaptation component 30 and/or determining component 36 to determine a difference between a sensitivity 38 of the receiver device (e.g., STA3 115-c) associated with the current rate 32 of data transmission and a sensitivity 40 of the receiver device associated with the new rate 34 of data transmission. In another aspect, block 404 may provide a means for determining a difference between a sensitivity of the receiver device associated with the current rate of data transmission and a sensitivity of the receiver device associated with the new rate of data transmission. For example, the means for determining may correspond to one or more of a STA1 115-a, processor 103, rate adaptation component 30, or determining component 36.

In an aspect, at block 406, method 400 includes comparing the difference with one or more sensitivity thresholds. In an aspect, for example, STA1 115-a may execute rate adaptation component 30 and/or comparing component 42 to compare the difference with one or more sensitivity thresholds 44. In another aspect, block 406 may provide a means for comparing the difference with one or more sensitivity thresholds. For example, the means for comparing may correspond to one or more of a STA1 115-a, processor 103, rate adaptation component 30, or comparing component 42.

In an aspect, at block 408, method 400 includes determining, at the transmitter device and based on the comparison, whether to apply the new rate of data transmission to the P2P connection. In an aspect, for example, STA1 115-a, may execute rate adaptation component 30 and/or determining component 36 to determine based on the comparison, whether to apply the new rate 34 of data transmission to the P2P connection. In another aspect, block 408 may provide a means for determining, at the transmitter device and based on the comparison, whether to apply the new rate of data transmission to the P2P connection. For example, the means for determining may correspond to one or more of a STA1 115-a, processor 103, rate adaptation component 30, or determining component 36.

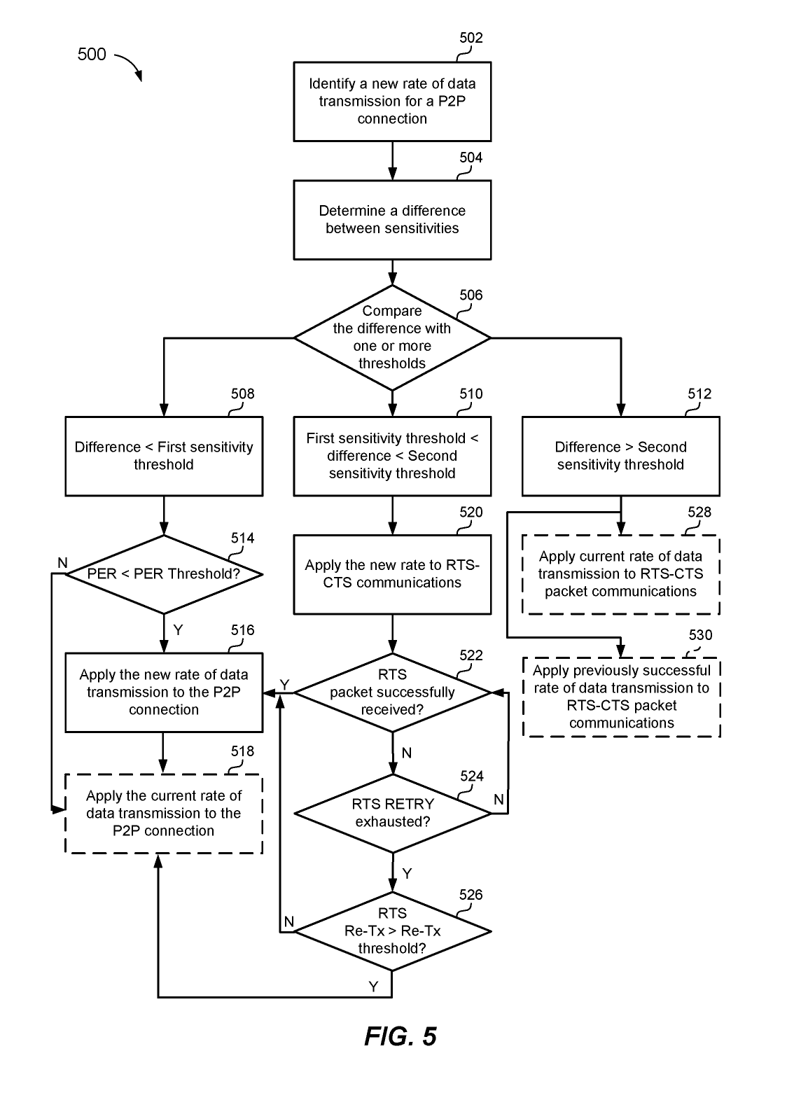

Referring to FIG. 5, an example of one or more operations of an aspect of rate adaptation component 30 (FIG. 2) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the rate adaptation component 30 is illustrated as having a number of subcomponents, it should be understood that one or more of the illustrated subcomponent may be separate from, but in communication with, the rate adaptation component 30 and/or each other.

Moreover, it should be understood that the following actions or components described with respect to the rate adaptation component 30 and/or its subcomponents may be performed by a specially-programmed processor, a processor executing specially-programmed software or computer-readable media, or by any other combination of a hardware component and/or a software component specially configured for performing the described actions or components.

In an aspect, at block 502, method 500 includes identifying, at a transmitter device, a new rate of data transmission for a point-to-point (P2P) connection with a receiver device, the new rate of data transmission being greater than a current rate of data transmission. In an aspect, for example, STA1 115-a may execute rate adaptation component 30 to identify a new rate 34 of data transmission for a P2P connection with a receiver device (e.g., STA3 115-c), the new rate 34 of data transmission being greater than a current rate 32 of data transmission.

In an aspect, at block 504, method 500 includes determining a difference between a sensitivity of the receiver device associated with the current rate of data transmission and a sensitivity of the receiver device associated with the new rate of data transmission. In an aspect, for example, STA1 115-a may execute rate adaptation component 30 and/or determining component 36 to determine a difference between a sensitivity 38 of the receiver device (e.g., STA3 115-c) associated with the current rate 32 of data transmission and a sensitivity 40 of the receiver device associated with the new rate 34 of data transmission.

In an aspect, at block 506, method 500 includes comparing the difference with one or more sensitivity thresholds. In an aspect, for example, STA1 115-a may execute rate adaptation component 30 and/or comparing component 42 to compare the difference with one or more sensitivity thresholds 44. For example, method 500 may proceed either to blocks 508, 510, or 512 depending on the comparison.

In an aspect, at block 508, method 500 includes determining that the difference is less than a first sensitivity threshold. In an aspect, for example, STA1 115-a may execute rate adaptation component 30 and/or comparing component 42 to determine that the difference is less than a first threshold 46.

In an aspect, at block 514, method 500 includes determining whether a PER of the current rate of data transmission is less than a PER threshold. In an aspect, for example, STA1 115-a may execute rate adaptation component 30 and/or determining component 36 to determine whether a PER of the current rate 32 of data transmission is less than a PER threshold. In an instance, if rate adaptation component 30 and/or determining component 36 determine that the PER of the current rate 32 of data transmission is less than a PER threshold, the method 500 may proceed to block 516. In another instance, if rate adaptation component 30 and/or determining component 36 determine that the PER of the current rate 32 of data transmission is not less than a PER threshold, the method 500 may proceed to block 518.

In an aspect, at block 516, method 500 includes applying the new rate of data transmission to the P2P connection. In an aspect, for example, STA1 115-a may execute rate adaptation component 30 to apply the new rate 34 of data transmission to the P2P connection.

In an aspect, at block 518, method 500 optionally includes applying the current rate of data transmission to the P2P connection. In an aspect, for example, STA1 115-a may execute rate adaptation component 30 to apply the current rate 32 of data transmission to the P2P connection.

In aspect, at block 510, method 500 includes determining that the difference is greater than a first sensitivity threshold and less than a second sensitivity threshold. In an aspect, for example, STA1 115-a may execute rate adaptation component 30 and/or comparing component 42 to determine that the difference is greater than a first threshold 46 and less than a second threshold 48.

In aspect, at block 520, method 500 includes applying the new rate of data transmission to RTS-CTS packet communications with the receiver device. In an aspect, for example, STA1 115-a may execute rate adaptation component 30 to apply the new rate 34 of data transmission to RTS-CTS packet (e.g., RTS packets 50 and CTS packets 52) communications with the receiver device (e.g., STA3 115-c).

In aspect, at block 522, method 500 includes determining whether one or more CTS packet transmissions are successfully received at the transmitter device. In an aspect, for example, STA1 115-a may execute rate adaptation component 30 and/or determining component 36 to determine whether one or more CTS packet 52 transmissions are successfully received at the transmitter device (e.g., STA1 115-a). In an instance, if rate adaptation component 30 and/or determining component 36 determine that one or more CTS packet 52 transmissions are successfully received at the transmitter device, the method 500 may proceed to block 526. In another instance, if rate adaptation component 30 and/or determining component 36 determine that one or more CTS packet 52 transmissions are not successfully received at the transmitter device, the method 500 may proceed to block 524.

In an aspect, at block 524, method 500 includes determining whether a RTS RETRY is exhausted. In an aspect, for example, STA1 115-a may execute rate adaptation component 30 and/or determining component 36 to determine whether a RTS RETRY, corresponding to the one or more RTS packets 50, is exhausted (e.g., no RTS packets (that have been retransmitted) were successfully communicated). In an instance, if rate adaptation component 30 and/or determining component 36 determine that the RTS RETRY is exhausted, the method 500 may proceed to block 526. In another instance, if rate adaptation component 30 and/or determining component 36 determine that the RTS RETRY is not exhausted, the method 500 may proceed to block 522.

In aspect, at block 526, method 500 includes determining whether a number of RTS packet retransmissions exceeds a retransmission threshold. In an aspect, for example, STA1 115-a may execute rate adaptation component 30 and/or determining component 36 to determine whether a number of RTS packet 50 retransmissions exceeds a retransmission threshold. In an instance, if rate adaptation component 30 and/or determining component 36 determine that a number of RTS packet 50 retransmissions exceeds a retransmission threshold, the method 500 may proceed to block 518. In another instance, if rate adaptation component 30 and/or determining component 36 determine that a number of RTS packet 50 retransmissions has not exceeded a retransmission threshold, the method 500 may return to block 522.

In aspect, at block 512, method 500 includes determining that the difference is greater than a second sensitivity threshold. In an aspect, for example, STA1 115-a may execute rate adaptation component 30 and/or comparing component 42 to determine that the difference is greater than a second threshold 48. As a result, method 500 may proceed to either optional block 526 or block 528 depending on the configuration of rate adaptation component 30 (FIG. 2).

In an aspect, at block 528, method 500 optionally includes applying the current rate of data transmission to RTS-CTS packet communications with the receiver device. In an aspect, for example, STA1 115-a may execute rate adaptation component 30 to apply the current rate 32 of data transmission to RTS-CTS packet communications with the receiver device (e.g., STA3 115-c).

In an aspect, at block 530, method 500 optionally includes applying a rate of data transmission corresponding to a previously successful rate of data transmission to RTS-CTS packet communications with the receiver device. In an aspect, for example, STA1 115-a may execute rate adaptation component 30 to apply a rate of data transmission corresponding to a previously successful rate of data transmission to RTS-CTS packet communications with the receiver device (e.g., STA3 115-c).

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for wireless communications, comprising:
identifying, at a transmitter device, a new rate of data transmission for a point-to-point (P2P) connection with a receiver device, the new rate of data transmission being greater than a current rate of data transmission;
determining a difference between a sensitivity of the receiver device associated with the current rate of data transmission and a sensitivity of the receiver device associated with the new rate of data transmission;
comparing the difference with one or more sensitivity thresholds; and
determining, at the transmitter device and based on the comparison, whether to apply the new rate of data transmission to the P2P connection.

2. The method of claim 1, wherein determining whether to apply the new rate of data transmission comprises:
determining whether application of the new rate of data transmission results in an increase in throughput for the P2P connection; and
applying the new rate of data transmission to the P2P connection in response to a determination that application of the new rate of data transmission results in increased throughput for the P2P connection.

3. The method of claim 1, wherein:
comparing the difference with the one or more sensitivity thresholds comprises determining that the difference is less than a first sensitivity threshold, and
determining whether to apply the new rate of data transmission to the P2P connection comprises:
determining whether a packet error rate (PER) of the current rate of data transmission is less than a PER threshold; and
applying the new rate of data transmission to the P2P connection in response to a determination that the difference is less than a first sensitivity threshold and that the PER of the current rate of data transmission is less than the PER threshold.

4. The method of claim 1, wherein:
comparing the difference with the one or more sensitivity thresholds comprises determining that the difference is greater than a first sensitivity threshold and less than a second sensitivity threshold, and
determining whether to apply the new rate of data transmission to the P2P connection comprises applying the new rate of data transmission to Request-to-Send/Clear-to-Send (RTS-CTS) packet communications with the receiver device in response to a determination that the difference is greater than the first sensitivity threshold and less than the second sensitivity threshold.

5. The method of claim 4, wherein applying the new rate of data transmission to RTS-CTS packet communications with the receiver device comprises:
transmitting to the receiver device an RTS packet indicating a transmit power of the transmitter device; and
receiving from the receiver device a CTS packet indicating a transmit power of the receiver device of the transmitter for the new rate.

6. The method of claim 4, wherein applying the new rate of data transmission to RTS-CTS packet communications with the receiver device comprises:
determining whether an RTS RETRY is exhausted based on a number of RTS packet retransmissions;
determining whether the number of RTS packet retransmissions exceeds a retransmission threshold in response to a determination that the RTS RETRY is not exhausted; and
applying the current rate of data transmission to the P2P connection in response to a determination that the number of RTS packet retransmissions exceeds the retransmission threshold.

7. The method of claim 4, wherein applying the new rate of data transmission to RTS-CTS packet communications with the receiver device comprises:
determining whether one or more RTS packet transmissions are successfully received at the receiver device;
applying the new rate of data transmission to the P2P connection in response to a determination that the one or more RTS transmissions are successfully received at the receiver device; and
ceasing RTS-CTS packet communications with the receiver device.

8. The method of claim 1, wherein:
comparing the difference with the one or more sensitivity thresholds comprises determining that the difference is greater than a first sensitivity threshold and a second sensitivity threshold, and
determining whether to apply the new rate of data transmission to the P2P connection comprises applying the current rate of data transmission to RTS-CTS packet communications with the receiver device in response to a determination that the difference is greater than the first sensitivity threshold and the second sensitivity threshold.

9. The method of claim 1, wherein:
comparing the difference with the one or more sensitivity thresholds comprises determining that the difference is greater than a first sensitivity threshold and a second sensitivity threshold, and
determining whether to apply the new rate of data transmission to the P2P connection comprises applying a rate of data transmission corresponding to a previously successful rate of data transmission to RTS-CTS packet communications with the receiver device in response to a determination that the difference is greater than the first sensitivity threshold and the second sensitivity threshold.

10. The method of claim 9, further comprising receiving an indication from a CTS frame for a highest possible rate of data transmission and one or more reserve bits in a service field of the CTS frame for a transmit power.

11. The method of claim 1, determining whether to apply the new rate of data transmission to the P2P connection comprises communicating, with the receiver device, one or both of short data packets or null data packets at the current rate of data transmission or the new rate of data transmissions based on the comparison of the difference with the one or more sensitivity thresholds.

12. An apparatus for wireless communication, comprising:
means for identifying, at a transmitter device, a new rate of data transmission for a point-to-point (P2P) connection with a receiver device, the new rate of data transmission being greater than a current rate of data transmission;
means for determining a difference between a sensitivity of the receiver device associated with the current rate of data transmission and a sensitivity of the receiver device associated with the new rate of data transmission;
means for comparing the difference with one or more sensitivity thresholds; and
means for determining, at the transmitter device and based on the comparison, whether to apply the new rate of data transmission to the P2P connection.

13. An apparatus for wireless communication, comprising:
a transceiver;
a memory configured to store data; and
one or more processors communicatively coupled with the transceiver and the memory, wherein the one or more processors and the memory are configured to:
identify, at a transmitter device, a new rate of data transmission for a point-to-point (P2P) connection with a receiver device, the new rate of data transmission being greater than a current rate of data transmission;
determine a difference between a sensitivity of the receiver device associated with the current rate of data transmission and a sensitivity of the receiver device associated with the new rate of data transmission;
compare the difference with one or more sensitivity thresholds; and
determine, at the transmitter device and based on the comparison, whether to apply the new rate of data transmission to the P2P connection.

14. The apparatus of claim 13, wherein the one or more processors and the memory are further configured to:
determine whether application of the new rate of data transmission results in an increase in throughput for the P2P connection; and
apply the new rate of data transmission to the P2P connection in response to a determination that application of the new rate of data transmission results in increased throughput for the P2P connection.

15. The apparatus of claim 13, wherein the one or more processors and the memory are further configured to:
determine that the difference is less than a first sensitivity threshold, and
determine whether a packet error rate (PER) of the current rate of data transmission is less than a PER threshold; and
apply the new rate of data transmission to the P2P connection in response to a determination that the difference is less than a first sensitivity threshold and that the PER of the current rate of data transmission is less than the PER threshold.

16. The apparatus of claim 13, wherein the one or more processors and the memory are further configured to:
determine that the difference is greater than a first sensitivity threshold and less than a second sensitivity threshold, and
apply the new rate of data transmission to Request-to-Send/Clear-to-Send (RTS-CTS) packet communications with the receiver device in response to a determination that the difference is greater than the first sensitivity threshold and less than the second sensitivity threshold.

17. The apparatus of claim 16, wherein the one or more processors and the memory are further configured to:
determine whether an RTS RETRY is exhausted based on a number of RTS packet retransmissions;
determine whether the number of RTS packet retransmissions exceeds a retransmission threshold in response to a determination that the RTS RETRY is not exhausted; and
apply the current rate of data transmission to the P2P connection in response to a determination that the number of RTS packet retransmissions exceeds the retransmission threshold.

18. The apparatus of claim 16, wherein the one or more processors and the memory are further configured to:
determine whether one or more RTS packet transmissions are successfully received at the receiver device;
apply the new rate of data transmission to the P2P connection in response to a determination that the one or more RTS transmissions are successfully received at the receiver device; and
cease RTS-CTS packet communications with the receiver device.

19. The apparatus of claim 13, wherein the one or more processors and the memory are further configured to:
determine that the difference is greater than a first sensitivity threshold and a second sensitivity threshold, and
apply the current rate of data transmission to RTS-CTS packet communications with the receiver device in response to a determination that the difference is greater than the first sensitivity threshold and the second sensitivity threshold.

20. The apparatus of claim 13, wherein the one or more processors and the memory are further configured to:
determine that the difference is greater than a first sensitivity threshold and a second sensitivity threshold, and
apply a rate of data transmission corresponding to a previously successful rate of data transmission to RTS-CTS packet communications with the receiver device in response to a determination that the difference is greater than the first sensitivity threshold and the second sensitivity threshold.
